(19) United States
(12) Patent Application Publication
(10) Pub. No.: US 2004/0263904 A1
(43) Pub. Date: Dec. 30, 2004

(54) Method and apparatus for processing print data

(75) Inventor: Sergey Sobko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/874,268

(22) Filed: Jun. 24, 2004

(30) Foreign Application Priority Data
Jun. 24, 2003 (KR) 2003-41055

(51) Int. Cl. G06F 15/00; G06K 9/54

(52) U.S. Cl. 358/1.15; 382/304

(57) ABSTRACT

A method of and apparatus for processing print data by simultaneously receiving print data from a plurality of host computers, sequentially decomposing the print data, and outputting decomposition results to a print engine. The method includes: storing a decomposition context of a current job when a new urgent job is requested to be processed and the current job is not urgent; decomposing print data for the new urgent job; and resuming decomposition of the interrupted current job using the stored decomposition context.

### CROSS-REFERENCE TO RELATED APPLICATION

This application claims the priority of Korean Patent Application No. 2003-41055, filed on Jun. 24, 2003, in the Korean Intellectual Property Office, the disclosure of which is incorporated herein by reference.

### BACKGROUND OF THE INVENTION

1. Field of the Invention

The present invention relates to printing, and more particularly, to a method and apparatus for processing print data provided from a host computer and a computer-readable recording medium storing a computer program which controls the apparatus.

2. Description of Related Art

A conventional apparatus for processing print data simultaneously receives print data transmitted from a plurality of host computers through a network, sequentially performs a decomposition process on the received print data, and outputs decomposition results to a print engine. During the decomposition process, print data are converted into data suitable for printing. Then, the print engine prints images corresponding to the decomposition results received from the apparatus for processing print data. Generally, the decomposition process is the most time-consuming part in processing print data.

In general, the conventional apparatus for processing print data includes an input unit, a processing unit, and an output unit. The input unit inputs print data transmitted from the host computer and buffers the print data. The processing unit decomposes the buffered print data and sends the decomposition results to the print engine via the output unit. Since the processing unit cannot separate the print data, namely, page description language (PDL) data into pages, the decomposition process must start from the beginning of PDL data. Accordingly, when the processing unit decomposes one page of data, although other print data are requested to be urgently processed, the decomposition process cannot be stopped. This is a major drawback of the conventional apparatus for processing print data. In this case, a large print job can monopolize all resources of the processing unit for a long time, and although other new print data have to be urgently processed, the new print data cannot be processed.

### BRIEF SUMMARY

The present invention provides a method of processing print data, which can temporarily interrupt a current job to process an urgent job ahead of other print jobs in a queue.

The present invention provides an apparatus for processing print data, which can temporarily interrupt a current job to process an urgent job ahead of other print jobs in a queue.

The present invention provides a computer-readable recording medium having recorded thereon a computer program for performing the method of processing print data by which a current job can be temporarily interrupted to process an urgent job ahead of other print jobs in a queue.

According to an aspect of the present invention, there is provided a method of processing print data by simultaneously receiving print data from a plurality of host computers, sequentially decomposing the print data, and outputting decomposition results to a print engine. The method includes: storing a decomposition context of a current job when a new urgent job is requested to be processed and the current job is not urgent; decomposing print data for the new urgent job; and resuming decomposition of the interrupted current job using the stored decomposition context.

According to another aspect of the present invention, there is provided an apparatus for processing print data by simultaneously receiving print data from a plurality of host computers, sequentially decomposing the print data, and outputting decomposition results to a print engine. The apparatus includes: a first storage section; a decomposition managing unit which determines a queue order in which the print data are to be decomposed, checks whether a new urgent job is requested to be processed, checks whether a current job is urgent, and respectively outputs check results as a first control signal and a second control signal; and a data processing unit which decomposes print data for the current job, stores in the first storage section a current decomposition context of the current job interrupted in response to the first control signal and the second control signal when the first control signal indicates that the new urgent job is to be processed and the second control signal indicates that the current job is not urgent, decomposes print data for the new urgent job, reads the stored decomposition context to determine whether the print data for the new urgent job is completely decomposed, and resumes decomposition of the interrupted current job.

According to yet another aspect of the present invention, there is provided a computer-readable recording medium encoded with processing instructions for performing a method of controlling a print data processing apparatus which processes print data by simultaneously receiving print data from a plurality of host computers, sequentially decomposing the print data, and outputting decomposition results to a print engine. The method includes: storing a decomposition context of a current job when a new urgent job is requested to be processed and the current job is not urgent; decomposing print data for the new urgent job; and resuming decomposition of the current job using the stored decomposition context.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIGS. 1A and 1B are a flowchart for explaining a method of processing print data according a first embodiment of the present invention;

FIG. 2 is a block diagram of a conventional printing system with which the print data processing method according to the first embodiment of the present invention is usable;

FIG. 3 is a flowchart for explaining a method of processing print data according to a second embodiment of the present invention;

FIG. 4 is a block diagram of an apparatus for processing print data according to either of the first or second embodiments of the present invention;

FIG. 5 is a block diagram of an example of the decomposition managing unit shown in FIG. 4;

FIG. 6 is a block diagram of another example of the decomposition managing unit and an example of the data processing unit shown in FIG. 4;

FIG. 7 is a block diagram of still another example of the decomposition managing unit and another example of the data processing unit shown in FIG. 4; and

FIG. 8 is a diagram of an example of the urgent processing request checking unit shown in FIGS. 6 and 7.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

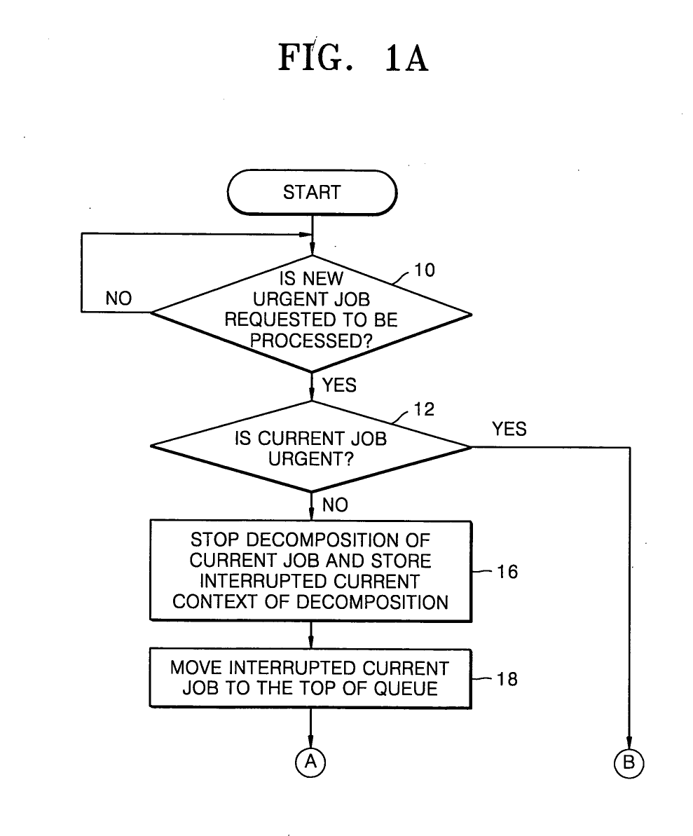

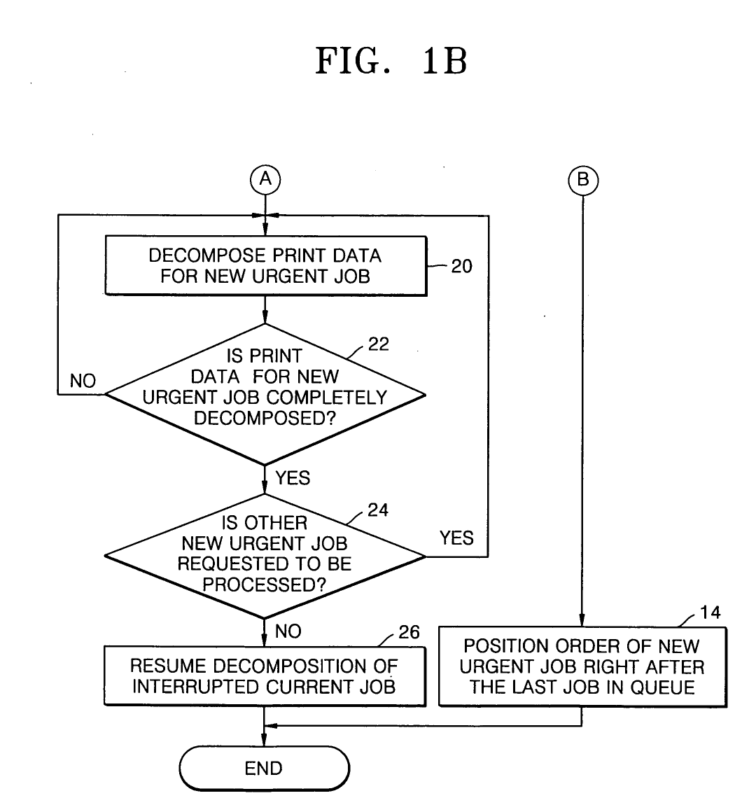

FIGS. 1A and 1B are a flowchart for explaining a method of processing print data according to a first embodiment of the present invention. The method includes storing a current decomposition context and determining the priority of the current job when a new urgent job is requested to be processed and a current job is not urgent in operation 10 through operation 18, decomposing print data for the new urgent job in operation 20 through operation 24, and resuming decomposition of the interrupted current job in operation 26.

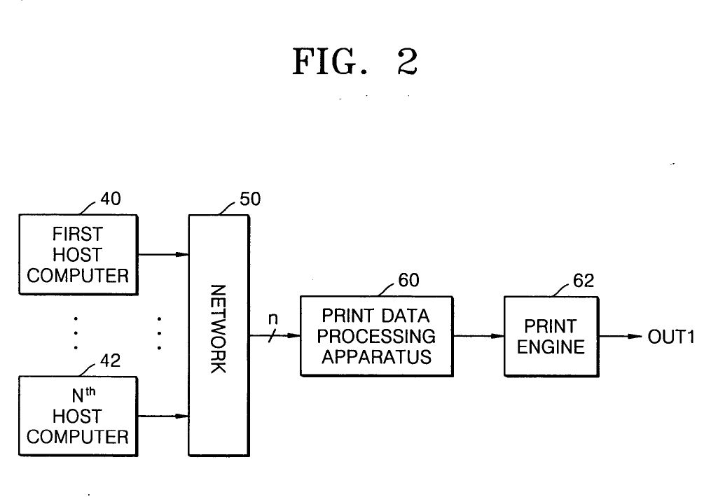

FIG. 2 is a block diagram of a conventional printing system with which the print data processing method according to the first embodiment of the present invention is usable. The conventional printing system includes first through n^{th} host computers, (n is a positive number greater than 2) 40 and 42, a network 50, a print data processing apparatus 60, and a print engine 62.

Referring to FIG. 2, the print data processing apparatus 60 simultaneously receives a plurality of print data from the first through n^{th} host computers 40 and 42 through the network 50, sequentially decomposes the plurality of print data, and outputs decomposition results to the print engine 62. Here, the first host computer 40 through the n^{th} host computer 42 may be personal computers. The print data processing apparatus 60 can decompose, for example, page description language (PDL) data and convert it into bitmap data.

Print data are generally print jobs coded in PDL. Print data comprise a digitized image data and a header. The header includes job identification factor (ID), job processing parameters, job category, etc. The job identification factor means the factor to identify buffered print data, and the job category is used to assign priority to a job to be processed. There are two categories of jobs: normal and urgent. The job category is assigned by a host computer and can be changed by a user. That is, whether or not a job to be processed is urgent is determined by the host computer and can be changed by the user.

The print engine 62 prints images corresponding to decomposition results input from the print data processing apparatus 60 and outputs printed results through an output terminal OUT1. The print data processing apparatus 60 performs the print data processing method illustrated in FIGS. 1A and 1B.

In the print data processing method according to the first embodiment of the present invention, a current decomposition context is stored when a new urgent job is requested to be processed and a current job is not urgent in operations 10 through 18. As used in the present embodiment, the new urgent job means a job that is requested to be urgently processed by the print data processing apparatus 60, and the current job means a job that is currently being processed by the print data processing apparatus 60.

Referring again to FIGS. 1A and 1B, in operation 10, it is determined whether or not a new urgent job is requested to be processed. If it is determined that the new urgent job is not requested to be processed, the process repeats operation 10. However, in operation 12, if it is determined that the new urgent job is requested to be processed, it is determined whether or not a current job is urgent. In operation 14, the order of the new urgent job is positioned right after the last urgent job in a queue if it is determined that the new urgent job is requested to be processed but the current job is more urgent. That is, since the current job is more urgent, after the decomposition process of the current job is completed, at least one other urgent job, if any, should be decomposed. After the decomposition of all the urgent jobs is completed, a priority of the new urgent job is determined as in operation 14 to decompose the new urgent job. For example, if the current job is more urgent and three other urgent jobs are scheduled to be processed after the current job, when a new urgent job is requested to be processed while the current job is being processed, the order of the new urgent job is positioned right after the last urgent job in the queue such that the new urgent job can be processed right after the current job and the three urgent jobs are completely decomposed.

While FIG. 1A shows a method of the first embodiment including operation 14, it is to be understood that operation 14 in the print data processing method illustrated in FIG. 1 may be omitted. In this case, if it is determined that the current job is urgent, the print data processing method described in FIGS. 1A and 1B is ended.

In operation 16, if it is determined that the current job is not urgent, a decomposition process of the current job is interrupted and an interrupted current decomposition context is stored. That is, since the current job is not urgent but normal, decomposition of the current job is stopped and the current decomposition context is stored for the moment in order to process the new urgent job.

In operation 18, the order of the interrupted current job is positioned to the top of the queue, and the interrupted current job can be resumed immediately after the decomposition of the new urgent job is completed.

When the new urgent job is requested to be processed and the current job is not urgent, the current decomposition context is stored and then, print data for the new urgent job are decomposed, in operation 20 through operation 24.

Referring to FIG. 2, in operation 20, print data for the new urgent job are decomposed. In operation 22, it is determined whether or not print data for the new urgent job is completely decomposed. If it is determined that print data for the new urgent-job is not completely decomposed, the process returns to operation 20 to continuously decompose print data for the new urgent job.

However, in operation 24, if it is determined that the print data for the new urgent job is completely decomposed, it is determined whether or not other new urgent job is requested to be processed. If it is determined that the other new urgent job is requested to be processed, the process returns to operation 20 to decompose print data for the other new urgent job.

According to the first embodiment of the present invention, the processing of the new urgent job or the processing of the other new urgent job can be directly requested by a user. In this case, the user can request the urgent job to be processed by operating a control panel (not shown), or the like.

According to a second embodiment of the present invention, the processing of the new urgent job or the other new urgent job can be requested by a corresponding host computer among the first through n^{th} host computers 40 and 42. In this case, the urgent job can be requested to be processed using a control application running on, by way of a non-limiting example, the corresponding host computer requesting the urgent jobs.

However, the second embodiment differs from the first in that in operation 26, if it is determined that the other new urgent job is not requested to be processed, decomposition of the interrupted current job is resumed using the stored decomposition context.

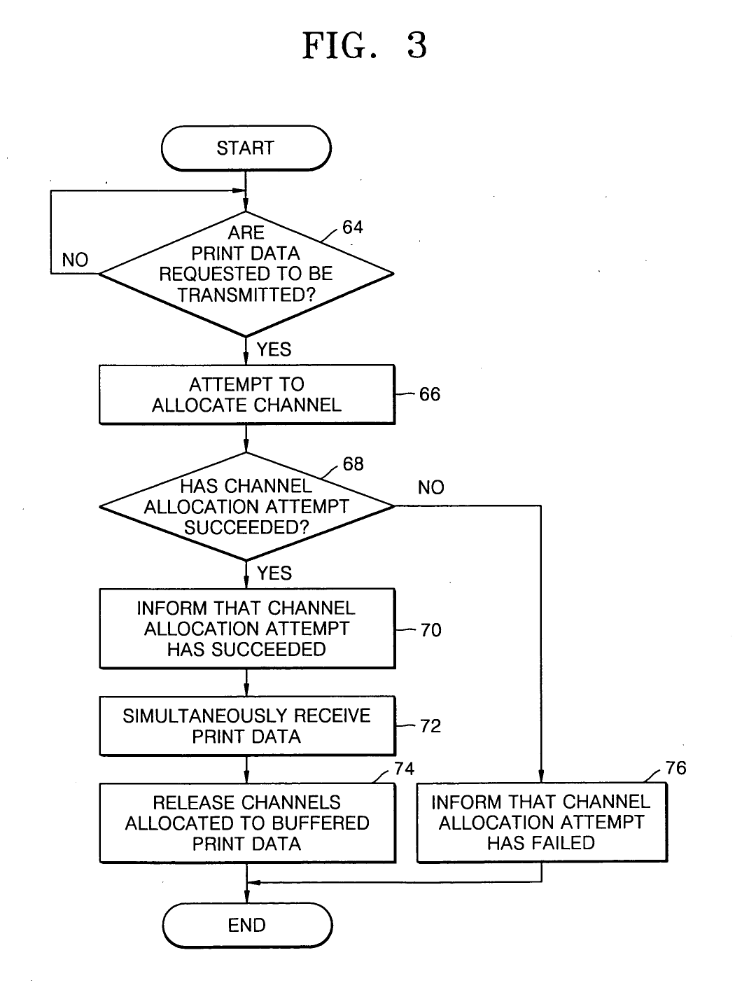

A method of processing print data using the print data processing apparatus 60 shown in FIG. 2, which receives print data from the plurality of host computers 40 through 42 through the network 50, will be explained with reference to FIG. 3.

FIG. 3 is a flowchart illustrating a method of processing print data according to the second embodiment of the present invention. The method includes attempting to allocate a channel when print data are requested to be transmitted in operation 66 and operation 64, respectively, and receiving and buffering the print data according as whether a channel allocation attempt has succeeded in operation 68 through operation 76.

First, in operation 64, it is determined whether or not print data are requested to be transmitted from a corresponding host computer among the first through n^{th} host computers 40 and 42. If it is determined that the print data are not requested to be transmitted, the process repeats operation 64. However, in operation 66, if it is determined that the print data are requested to be transmitted, an attempt to allocate a channel through which the print data are transmitted from the corresponding host computer is made. In operation 68, it is determined whether or not the channel allocation attempt has succeeded.

In operation 76, if it is determined that the channel allocation attempt has failed, this determination is communicated to the corresponding host computer. Conversely, in operation 70, if it is determined that the channel allocation attempt has succeeded, this determination is communicated to the corresponding host computer. In operation 72, after preparing the receiving the print data from the host computer to which the channel is allocated, the print data are simultaneously received from all the host computers to which the channels are allocated so as to be buffered. In operation 74, the channel allocated to the corresponding host computer which has buffered print data is released.

The print data processing apparatus 60 described in FIG. 2 extracts and decomposes print data for the current job among the buffered print data, or extracts and decomposes print data for the new urgent job among the buffered print data. That is to say, data decomposed by the print data processing apparatus 60 are buffered data.

Construction and operation of an apparatus for processing print data is explained below with reference to FIGS. 1A, 1B, 3, and 4.

FIG. 4 is a block diagram of a print data processing apparatus according to a preferred embodiment of the present invention. The apparatus includes an input unit 80, an input buffer 82, a data processing unit 84, an output buffer 86, an output unit 88, a first storage 90, and a decomposition managing unit 92.

The print data processing apparatus shown in FIG. 4 can perform the print data processing methods described with reference to FIGS. 1 and 3. That is, the apparatus of FIG. 4 performs the methods of the first and second embodiments of the present invention.

The input unit 80 shown in FIG. 4 simultaneously receives print data transmitted from a first through n^{th} host computer through the network through an input terminal IN1, and outputs the input print data to the input buffer 82. The input unit 80 inputs print data through multiple channels to prevent large print data from occupying one channel for a long time and thus interfering with input of other print data.

For example, print data can be transmitted to the input unit 80 of the print data processing apparatus from the corresponding host computer among the host computers. That is, the input unit 80 shown in FIG. 4 can perform the print data processing method described in FIG. 3.

First, to perform operation 64, the input unit 80 checks whether or not a message indicating the host computer will transmit print data is input from the corresponding host computer through the input terminal IN1. If the message is input, to perform operation 66, the input unit 80 attempts to allocate a channel through which the print data will be transmitted from the corresponding host computer. Here, the message contains a header of the print data, and the input unit 80 outputs the header of the print data input through the input terminal IN1 from the corresponding host computer to the decomposition managing unit 92. To perform operation 68, the input unit 80 checks whether or not a channel allocation attempt has succeeded. If the channel cannot be allocated, to perform operation 76, the input unit 80 transmits a negative acknowledge signal indicating that the channel allocation attempt has failed, to the corresponding host computer through an output terminal OUT2. Therefore, the corresponding host computer recognizes through the negative acknowledgement signal that the channel has not been allocated and thus, can transmit the message to the input unit 80 again after a specified period of time lapses. Meantime, if the channel can be allocated, to perform operation 70, the input unit 80 transmits a positive acknowledgement signal indicating that the channel allocation attempt has succeeded to the corresponding host computer through the output terminal OUT2. Therefore, the corresponding host computer recognizes through the positive acknowledgement signal that the channel has been allocated. To perform operation 72, the input unit 80 simultaneously receives print data through the input terminal IN1 from the corresponding host computers which perceive that the channels have been allocated, among the host computers, and outputs the received print data to the input buffer 82. Here, the buffered print data are digitized image data. Once the print data are buffered by the input buffer 82, to perform operation 74, the input unit 80 releases the channel allocated to the corresponding host computer which has buffered print data. Here, the input buffer 82 buffers the print data input from the input unit 80 under the control of the decomposition managing unit 92, and outputs buffered results to the data processing unit 84.

The decomposition managing unit 92 checks whether or not the new urgent job is requested to be processed to perform operation 10 of FIG. 1A, checks whether or not the current job is urgent to perform operation 12 of FIG. 1A, and outputs respective check result as a first control signal C1 and a second control signal C2 to the data processing unit 84.

To perform operation 14 of FIG. 1B, the decomposition managing unit 92 positions the order of the new urgent job right after the last urgent job in the queue in response to the first control signal C1 and the second control signal C2 generated thereby. That is, if it is perceived through the first control signal C1 that the new urgent job is requested to be processed but if it is perceived through the second control signal C2 that the current job is more urgent, the decomposition managing unit 92 performs operation 14.

While the data processing unit 84 shown in FIG. 4 receives and decomposes print data for the current job input from the input buffer 82, to perform operation 16 of FIG. 1A, the data processing unit 84 stops decomposition of the current job in response to the first control signal C1 and the second control signal C2 input from the decomposition managing unit 92 and stores the current decomposition context in the first storage 90. That is, if it is perceived through the first control signal C1 that the new urgent job is requested to be processed and if it is determined through the second control signal C2 that the current job is not urgent, the data processing unit 84 performs operation 16. Furthermore, to perform operation 20 of FIG. 1B, the data processing unit 84 inputs print data for the new urgent job read from the input buffer 82 under the control of the decomposition managing unit 92 and decomposes the input print data for the new urgent job. In the event that the print data processing method described in FIG. 1 does not include operation 24, to perform operation 26 of FIG. 1B according as whether print data for the new urgent job is completely decomposed, the data processing unit 84 inputs the stored decomposition context from the first storage and resumes decomposition of the interrupted current job using the input context of decomposition.

To perform operation 18 of FIG. 1A, the decomposition managing unit 92 positions the order of the interrupted current job to the top of the queue. The decomposition managing unit 92 performing operations 14 and 18 in this manner determines and controls the order of queue in which jobs are processed by the data processing unit 84.

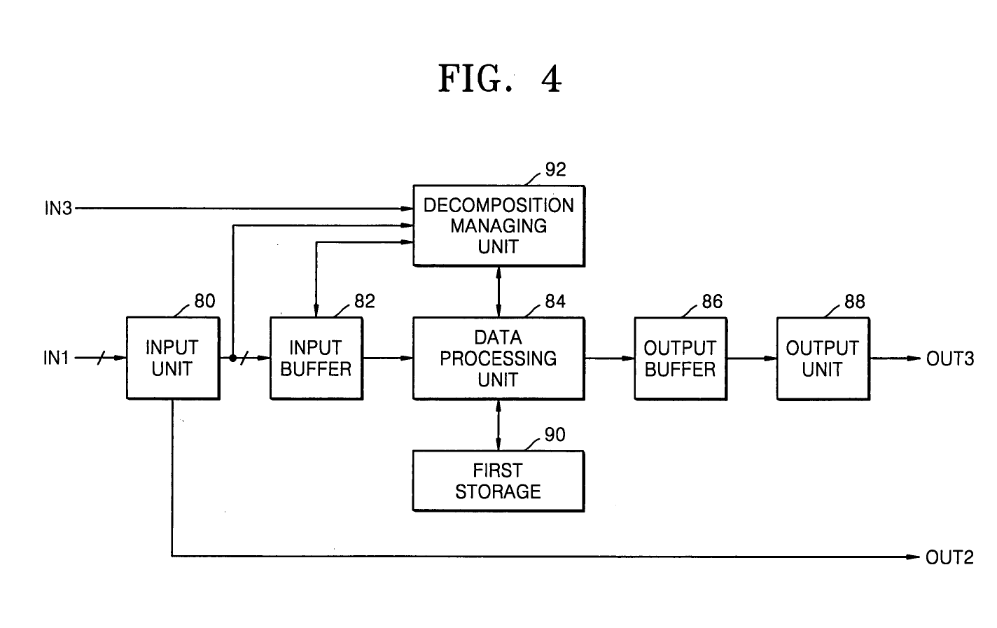

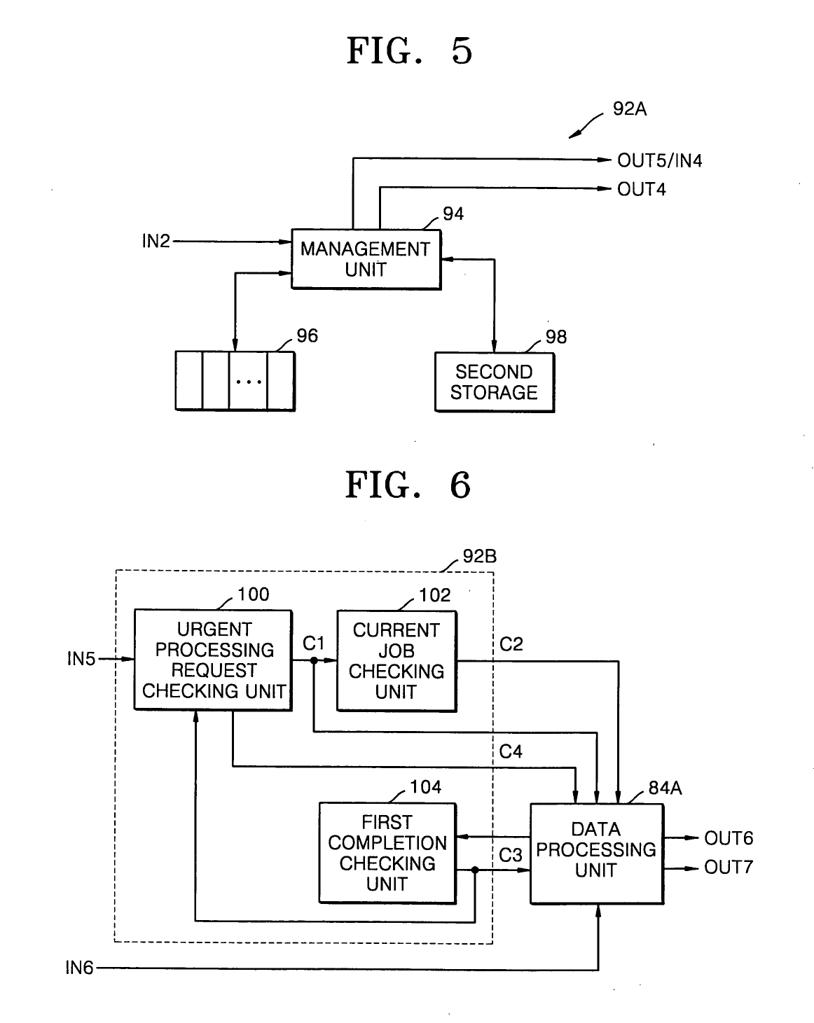

FIG. 5 is a block diagram of an example 92A of the decomposition managing unit 92 shown in FIG. 4. This modified decomposition managing unit 92A includes a management unit 94, a queue buffer 96, and a second storage 98.

The queue buffer 96 shown in FIG. 5 inputs the order of a queue, in which print data are decomposed, from the management unit 94 and stores the input order of queue. Here, the second storage 98 stores job information generated by the management unit 94 and outputs the stored job information to the management unit 94.

The management unit 94 generates job information from a header of print data input through an input terminal IN2 from the input unit 80 and stores the generated job information in the second storage 98. Here, job information includes job identification factor, job category, location information, etc. Here, location information is used to trace current location of buffered print data to be decomposed. That is, the decomposition managing unit 92 reads print data necessary for performing operation 20 of FIG. 1B from the input buffer 82 using the location information and outputs the read print data to the data processing unit 84.

In addition, the management unit 94 determines an order of processing print data to be output to the data processing unit 84 from the input buffer 82 based on print data input from the input unit 80 through the input terminal IN2 and the job information stored in the second storage 98, and stores the determined order in the queue buffer 96. For example, the management unit 94 determines an order of processing print data so that an urgent job is processed earlier than normal jobs with reference to job category within the job information stored in the second storage 98. The management unit 94 checks whether or not a job is requested by host computer to be urgently processed with reference to a header of print data input from the input unit 80, and determines the order of queue reflecting check results. Alternatively, the management unit 94 checks whether or not an urgent processing request signal is input through an input terminal IN3 from a control panel or the like operated by a user, and can determine the order of queue reflecting check results. For example, when the queue buffer 96 employs a first-in-first-out (FIFO) order, the management unit 94 records in the FIFO according to the order job identification factor with respect to jobs to be processed in the determined order. That is, job identification factor with respect to a job having priority over other job is earlier input to the FIFO than that with respect to the order job. Here, job identification factor with respect to jobs which are already completely processed in the data processing unit 84 is removed from the FIFO.

The management unit 94 generates an address using the order input from the queue buffer 96 and the location information input from the second storage 98, and outputs the generated address to the input buffer 82 through an output terminal OUT4. Therefore, the input buffer 82 outputs buffered print data to the data processing unit 84 in response to the address input from the management unit 94. As a result, the management unit 94 generates the address with reference to the location information based on the recognized location order read from the queue buffer 96, so as to output the print data from the input buffer 82 to the data processing unit 84 according to the determined order stored in the queue buffer 96.

Furthermore, the management unit 94 outputs the control signal C1 and the second control signal C2, which are generated after checking whether or not the new urgent job is requested to be processed and the current job is urgent, to the data processing unit 84 through an output terminal OUT5, and inputs a signal, which will be explained below, necessary for performing operation 24 of FIG. 1B from the data processing unit 84 through an input terminal IN4.

The decomposition managing unit 92 shown in FIG. 4 may include a separate second storage 98 as shown in FIG. 5. The decomposition managing unit 92 may also use the first storage 90 instead of the second storage 98. In this case, job information is stored in the first storage 90.

FIG. 6 is a block diagram of other examples (92B and 84A) of the of the decomposition managing unit 92 and the data processing unit 84, respectively, shown in FIG. 4.

To perform operations 10 and 12 of FIG. 1A, the decomposition managing unit 92B may include an urgent processing request checking unit 100 and a current job checking unit 102. The urgent processing request checking unit 100 checks whether or not a new urgent job is requested to be processed and respectively outputs a check result as a first control signal C1 to the current job checking unit 102 and a data processing unit 84A. For example, when the new urgent job is requested to be processed not by a user but by the corresponding host computer among the first through n^{th} host computers, the urgent processing request checking unit 100 receives an urgent job processing request signal, that requests new urgent job to be processed, transmitted from the corresponding host computer through the input unit 80 through an input terminal IN5, and generates the first control signal C1 in response to the urgent job processing request signal. The current job checking unit 102 checks whether or not the current job is urgent in response to the first control signal C1 input from the processing request checking unit 100, and outputs a check result as a second control signal C2 to the data processing unit 84A. For example, if it is perceived through the first control signal C1 that the new urgent job is requested to be processed, the current job checking unit 102 checks whether or not the current job being decomposed is urgent.

To perform operation 16 of FIG. 1A, the data processing unit 84A stops decomposition of the current job in response to the first control signal C1 and the second control signal C2 input from the decomposition managing unit 92B and outputs the interrupted current decomposition context through an output terminal OUT6 to store the context of decomposition in the first storage 90. For example, if it is perceived through the fist control signal C1 that the new urgent job is requested to be processed and if it is perceived through the second control signal C2 that the current job is not urgent, the data processing unit 84A performs operation 16.

To perform operation 20 (shown in FIG. 1B), the data processing unit 84A inputs print data for the new urgent job through an input terminal IN6 from the input buffer 82, decomposes the input print data, and outputs decomposition results through an output terminal OUT7.

To perform operation 22 of FIG. 1B, the decomposition managing unit 92B shown in FIG. 6 may further include a first completion checking unit 104. The first completion checking unit 104 checks whether or not print data for the new urgent job is completely decomposed by looking up the data processing unit 84A, and respectively outputs a check result as a third control signal C3 to the data processing unit 84A and the urgent processing request checking unit 100. When the print data processing method described in FIG. 1 does not include operation 24 of FIG. 1B, to perform operation 26 of FIG. 1B, the data processing unit 84A reads the context of decomposition stored in the first storage 90 in response to the third control signal C3 input from the first completion checking unit 104 to input the context of decomposition through the input terminal IN6, resumes decomposition of the interrupted current job using the input context of decomposition, and outputs decomposition results through the output terminal OUT7. For example, if it is perceived through the third control signal C3 that print data for the new urgent job is completely decomposed, the data processing unit 84A performs operation 26.

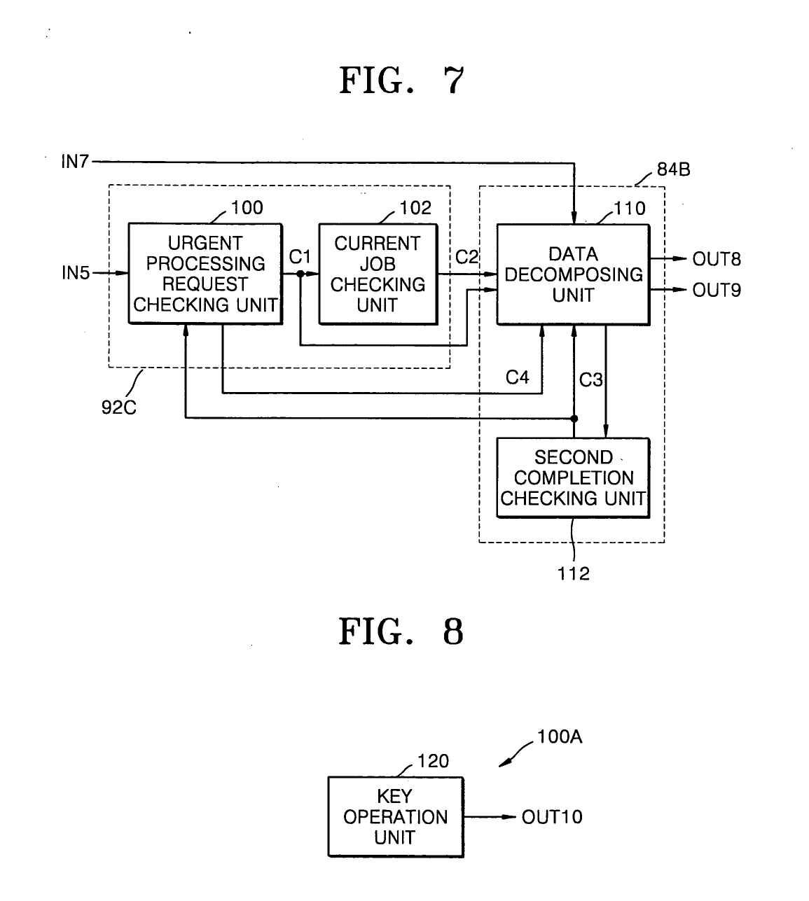

FIG. 7 is a block diagram of still another example 92C of the decomposition managing unit 92 and another example 84B of the data processing unit 84 shown in FIG. 4.

The decomposition managing unit 92C shown in FIG. 7 includes an urgent processing request checking unit 100 and a current job checking unit 102 to perform operations 10 and 12 of FIG. 1A. Since the urgent processing request checking unit 100 and the current job checking unit 102 shown in FIG. 7 perform the same functions as those shown in FIG. 6, they will not be further described. The decomposition managing unit 92C does not include a first completion checking unit 104, in contrast to the decomposition managing unit 92B shown in FIG. 6.

The data processing unit 84B includes a data decomposing unit 110 to perform operations 16 and 20 of FIGS. 1A and 1B, respectively. First, to perform operation 16, the data decomposing unit 110 stops decomposition of the current job in response to a first control signal C1 and a second control signal C2 input from the decomposition managing unit 92C during decomposing the print data for current job, outputs an interrupted current decomposition context through an output terminal OUT8, and stores the context of decomposition in the first storage 90. For example, if it is perceived through the first control signal C1 that the new urgent job is requested to be processed and if it is determined through the second control signal C2 that the current job is not urgent, the data decomposing unit 110 performs operation 16. To perform operation 20, the data decomposing unit 110 inputs and decomposes print data for the new urgent job through an input terminal IN7 from the input buffer 82 and outputs decomposition results through an output terminal OUT9.

The data processing unit 84B shown in FIG. 7 may include a second completion checking unit 112 to perform operation 22 of FIG. 1B. The second completion checking unit 112 checks whether or not the print data for the new urgent job is completely decomposed by looking up the data decomposing unit 110, and respectively outputs a check result as a third control signal C3 to the data decomposing unit 110 and the urgent processing request checking unit 100. When the print data processing method described in FIG. 1 does not include operation 24 of FIG. 1B, to perform operation 26 of FIG. 1B, the data decomposing unit 110 of the data processing unit 84B reads the context of decomposition stored in the first storage 90 to input the context of decomposition through the input terminal IN7 in response to the third control signal C3 input from the second completion checking unit 112, resumes decomposition of the interrupted current job using the input context of decomposition, and outputs decomposition results through the output terminal OUT9. For example, if it is perceived through the third control signal C3 that the print data for the new urgent job is completely decomposed, the data decomposing unit 110 performs operation 26.

The urgent processing request checking unit 100 shown in FIGS. 6 and 7 performs operation 24 illustrated in FIG. 1B as well.

First, the urgent processing request checking unit 100 shown in FIG. 6 checks whether or not other new urgent job is requested to be processed in response to the third control signal C3 input from the first completion checking unit 104, and outputs a check result as a fourth control signal C4 to the data processing unit 84A. For example, if it is perceived through the third control signal C3 that print data for the other new urgent job is completely processed, the urgent processing request checking unit 100 checks whether or not a signal requesting the process of the other new urgent job is input through the input terminal IN5. If it is perceived through the fourth control signal C4 input from the urgent processing request checking unit 100 that other new urgent job is not requested to be processed, to perform operation 26 of FIG. 1B, the data processing unit 84A reads the context of decomposition stored in the first storage 90 to input the stored context of decomposition through the input terminal IN6, resumes decomposition of the interrupted current job using the input context of decomposition, and outputs the resumed decomposition results through the output terminal OUT7. However, if it is perceived through the fourth control signal C4 input from the urgent processing request checking unit 100 that other new urgent job is requested to be processed, to perform operation 20 of FIG. 1B, the data processing unit 84A decomposes print data for the other new urgent job input from the input buffer 82 through the input terminal IN6.

Similarly, the urgent processing request checking unit 100 shown in FIG. 7 checks whether or not other new urgent job is requested to be processed in response to the third control signal C3 input from the second completion checking unit 112, and outputs a check result as a fourth control signal to the data decomposing unit 110. For example, if it is perceived through the third control signal C3 that the print data for the other new urgent job is completely processed, the urgent processing request checking unit 100 checks whether or not the signal requesting the process of the other new urgent job is input through the input terminal IN5. If it is perceived through the fourth control signal C4 input from the urgent processing request checking unit 100 that the other new urgent job is not requested to be processed, to perform operation 26 of FIG. 1B, the data decomposing unit 110 reads the context of decomposition stored in the first storage 90 to input the stored context of decomposition through the input terminal IN7, resumes decomposition of the interrupted current job using the input context of decomposition, and outputs resumed decomposition results through the output terminal OUT9. If it is perceived through the fourth control signal C4 input from the urgent processing request checking unit 100 that the other new urgent job is requested to be processed, to perform operation 20, the data decomposing unit 110 decomposes print data for the other new urgent job input from the input buffer 82 through the input terminal IN7.

The decomposition managing unit 92B or 92C respectively shown in FIGS. 6 and 7 may serve as the management unit 94 shown in FIG. 5.

FIG. 8 is a diagram of an example 100A of the urgent processing request checking unit 100 shown in FIGS. 6 and 7. The modified urgent processing request checking unit 100A includes a key operation unit 120.

The key operation unit 120 functioning as the aforementioned control panel (not shown) is operated by a user who requests a new job to be urgently processed to generate a first control signal C1 and outputs the generated first control signal C1 through an output terminal OUT10.

Meanwhile, the output buffer 86 shown in FIG. 4 receives and buffers decomposition results obtained from the data processing unit 84, and outputs buffered results to the output unit 88. The output unit 88 outputs the buffered results obtained from the output buffer 86 to a print engine such as, for example, the print engine 62 shown in FIG. 2, through the output terminal OUT3.

A computer-readable recording medium storing a computer program which controls the print data processing apparatus will be described below.

The computer-readable recording medium stores a computer program for controlling the print data processing apparatus, according to a process. The process comprises storing a current decomposition context with respect to a current job when a new urgent job is requested to be processed and the current job is not urgent, decomposing print data for the new urgent job, and resuming decomposition of the interrupted current job using the stored decomposition context.

The process further includes positioning the order of the new urgent job right after the last urgent job in a queue when the new urgent job is requested to be processed but the current job is more urgent.

The operation of storing the context of decomposition includes determining whether or not a new urgent job is requested to be processed, determining whether or not a current job is urgent if it is determined that the new urgent job is requested to be processed, and stopping decomposition of the current job if it is determined that the current job is not urgent and storing an interrupted current decomposition context. Further, the operation of storing the context of decomposition may further include positioning the order of the interrupted current job to the top of the queue.

The operation of decomposing print data for the new urgent job includes determining whether or not print data for the new urgent job is completely decomposed and continuously decomposing the print data for the new urgent job if it is determined that the print data for the new urgent job is not completely decomposed.

As described above, the print data processing method and apparatus and the computer-readable recording medium storing the computer program according to the disclosed embodiments of the present invention can interrupt the current job which is not urgent when the new urgent job is requested to be processed, and resume the interrupted current job after completion of the process of the new urgent job. That is to say, the disclosed embodiments of the present invention allows the current job to be temporarily interrupted in order for the new urgent job to be processed, thereby promptly process urgent jobs.

Although a few embodiments of the present invention have been shown and described, the present invention is not limited to the described embodiments. Instead, it would be appreciated by those skilled in the art that changes may be made in these embodiments without departing from the principles and spirit of the invention, the scope of which is defined by the claims and their equivalents.

What is claimed is:

1. A method of processing print data by simultaneously receiving print data from a plurality of host computers, sequentially decomposing the print data, and outputting decomposition results to a print engine, comprising:
storing a decomposition context of a current job when a new urgent job is requested to be processed and the current job is not urgent;
decomposing print data for the new urgent job; and
resuming decomposition of the interrupted current job using the stored decomposition context.

2. The method of claim 1, further comprising positioning the new urgent job immediately after the last urgent job in a queue when the new urgent job is requested to be processed and the current job is determined to be more urgent.

3. The method of claim 1, wherein the storing includes:
determining whether the new urgent job is requested to be processed;
determining whether the current job is urgent when it is determined that the new urgent job is requested to be processed; and
stopping decomposition of the current job and storing the decomposition context when it is determined that the new urgent job is requested to be processed and the current job is not urgent.

4. The method of claim 3, wherein the request to process the new urgent job is made by a user.

5. The method of claim 3, wherein the request to process the new urgent job is made by a host computer.

6. The method of claim 3, wherein the storing further includes positioning the interrupted current job at the top of a queue when the new urgent job to be processed and the current job is not more urgent.

7. The method of claim 1, wherein the decomposing includes determining whether the print data for the new urgent job is completely decomposed, and continuing the decomposing when it is determined that the print data for the new urgent job is not completely decomposed.

8. The method of claim 7, wherein the decomposing includes determining whether another new urgent job is requested to be processed when it is determined that the print data for the new urgent job is completely decomposed, and decomposing print data for the another new urgent job if when is determined that the another new urgent job is requested to be processed.

9. The method of claim 8, wherein, when it is determined that the another new urgent job is not requested to be processed, decomposition of the interrupted current job is resumed using the stored decomposition context.

10. The method of claim 1, further comprising:
determining whether the print data are requested to be transmitted from a corresponding host computer among the plurality of host computers;
attempting to allocate a channel through which the print data are transmittable from the corresponding host computer when it is determined that the print data are requested to be transmitted;
determining whether the channel allocation attempt has succeeded;
informing the corresponding host computer that the channel has not been allocated when it is determined that the channel allocation attempt has failed;
informing the corresponding host computer that the channel has been allocated when it is determined that the channel allocation attempt has succeeded;
simultaneously receiving the print data from the corresponding host computer to which the channel has been allocated and buffering the received print data; and
releasing the channel allocated to the corresponding host computer which has buffered print data,
wherein the buffered print data are one of print data for the current job and print data for the new urgent job.

11. An apparatus for processing print data by simultaneously receiving print data from a plurality of host computers, sequentially decomposing the print data, and outputting decomposition results to a print engine, comprising:
a first storage section;
a decomposition managing unit which determines a queue order in which the print data are to be decomposed, checks whether a new urgent job is requested to be processed, checks whether a current job is urgent, and respectively outputs check results as a first control signal and a second control signal; and
a data processing unit which decomposes print data for the current job, stores in the first storage section a current decomposition context of the current job interrupted in response to the first control signal and the second control signal when the first control signal indicates that the new urgent job is to be processed and the second control signal indicates that the current job is not urgent, decomposes print data for the new urgent job, reads the stored decomposition context according to the result of determining whether the print data for the new urgent job is completely decomposed, and resumes decomposition of the interrupted current job.

12. The apparatus of claim 11, further comprising:
an input unit which simultaneously inputs the print data from the plurality of host computers;
an input buffer which buffers the print data input from the input unit and outputs buffered results under the control of the decomposition managing unit;
an output buffer which inputs and buffers decomposition results of the data processing unit; and
an output unit which outputs buffered results of the output buffer to the print engine.

13. The apparatus of claim 12, wherein the decomposition managing unit includes:
a queue buffer which stores the queue order;
a second storage section which stores job information; and
a management unit which generates the job information from the print data input from the input unit to store the job information in the second storage, determines, from the print data and the job information, a processing order to store the order in the queue buffer, outputs an address generated using the processing order and the job information, and checks whether the new urgent job is requested to be processed and the current job is urgent to respectively generate the first control signal and the second control signal,
wherein the input buffer outputs the print data buffered in response to the address to the data processing unit.

14. The apparatus of claim 13, wherein the management unit generates the job information from a header of the input print data.

15. The apparatus of claim 14, wherein the job information includes at least one of a job identification factor, a job category, and location information usable to trace a current location of buffered print data to be decomposed.

16. The apparatus of claim 11, wherein the decomposition managing unit positions the new urgent job right after the last urgent job in the queue in response to the first control signal and the second control signal.

17. The apparatus of claim 13, wherein the second storage section is part of the first storage section.

18. The apparatus of claim 11, wherein the decomposition managing unit positions the interrupted current job at the top of the queue.

19. The apparatus of claim 11, wherein the decomposition managing unit includes:
an urgent processing request checking unit which checks whether the new urgent job is requested to be processed and outputs a check result as the first control signal; and
a current job checking unit which checks whether the current job is urgent in response to the first control signal when the first control signal indicates that the new urgent job is requested to be processed and outputs a check result as the second control signal,
wherein the data processing unit stops decomposition of the current job in response to the first control signal and the second control signal when the second control signal indicates that the current job is urgent, and stores the decomposition context of the interrupted current job.

20. The apparatus of claim 19, wherein the urgent processing request checking unit includes a key operation unit which generates the first control signal in response to a user input.

21. The apparatus of claim 19, wherein the urgent processing request checking unit inputs an urgent job processing request signal to request the new urgent job to be processed from the host computer and generates the first control signal in response to the urgent job processing request signal.

22. The apparatus of claim 19, wherein the decomposition managing unit further includes a first completion checking unit which checks whether print data for the new urgent job is completely decomposed and outputs a check result as a third control signal, and the data processing unit reads the stored context of decomposition in response to the third control signal and resumes decomposition of the interrupted current job when the third control signal indicates that the new urgent job is completely disposed.

23. The apparatus of claim 19, wherein the data processing unit includes:
a data decomposing unit which decomposes print data for the current job, stores the current decomposition context in the first storage in response to the first control signal and the second control signal when the first control signal indicates that the new urgent job is requested to be processed and the second control signal indicates that the current job is not urgent, decomposes print data for the new urgent job, and reads the stored decomposition context in response to a third control signal to resume decomposition of the interrupted current job when the third control signal indicates that the new urgent job is completely decomposed; and
a second completion checking unit which checks whether the print data for the new urgent job is completely decomposed and outputs the check result as the third control signal.

24. The apparatus of claim 23, wherein the urgent processing request checking unit checks whether another new urgent job is requested to be processed in response to the third control signal and outputs a check result as a fourth control signal, and the data processing unit reads the stored context of decomposition in response to the fourth control signal and resumes decomposition of the interrupted current job when the fourth control signal indicates that the new another urgent job is not requested to be processed.

25. A computer-readable recording medium encoded with processing instructions for performing a method of controlling a print data processing apparatus which processes print data by simultaneously receiving print data from a plurality of host computers, sequentially decomposing the print data, and outputting decomposition results to a print engine, the method comprising:
storing a decomposition context of a current job when a new urgent job is requested to be processed and the current job is not urgent;
decomposing print data for the new urgent job; and
resuming decomposition of the current job using the stored decomposition context.

26. The computer-readable recording medium of claim 25, further comprising positioning the new urgent job immediately after the last urgent job in a queue when the new urgent job is to be processed and the current job is more urgent.

27. The computer-readable recording medium of claim 26, wherein the storing includes:
determining whether the new urgent job is to be processed;
determining whether the current job is urgent when it is determined that the new urgent job is to be processed; and
stopping decomposition of the current job and storing the interrupted current decomposition context when the new urgent job is to be processed and it is determined that the current job is not urgent.

28. The computer-readable recording medium of claim 27, wherein the storing includes positioning the interrupted current job at the top of the queue.

29. The computer-readable recording medium of claim 25, wherein includes determining whether the print data for the new urgent job is completely decomposed, and continuing the decomposing when it is determined that the print data for the new urgent job is not completely decomposed.
